(19) United States
(12) Patent Application Publication
(10) Pub. No.: US 2024/0168457 A1
(43) Pub. Date: May 23, 2024

(54) POWDER RECLAMATION

(71) Applicant: Hewlett-Packard Development Company, L.P., Spring, TX (US)

(72) Inventors: Jacob Tyler WRIGHT, San Diego, CA (US); Maria Fabiola LEYVA MENDIVIL, Guadalajara, JAL (MX); Sunil KOTHARI, Palo Alto, CA (US); Lei CHEN, Shanghai (CN); Jun ZENG, Palo Alto, CA (US)

(21) Appl. No.: 18/283,365

(22) PCT Filed: Mar. 26, 2021
(86) PCT No.: PCT/US2021/024346

§ 371 Date: Sep. 21, 2023

(51) Int. Cl. G05B 19/4099

(52) U.S. Cl. CPC G05B 19/4099; G05B 2219/49023

(57) ABSTRACT

Examples of methods for powder reclamation are described. In some examples, a method includes estimating powder degradation for voxels of a three-dimensional (3D) manufacturing build based on a simulation. In some examples, the method includes determining a quantity of reclamation powder. In some examples, the quantity of reclamation powder may be determined based on the estimated powder degradation.

### BACKGROUND

Additive manufacturing is a technique to form three-dimensional (3D) objects by adding material until the object is formed. The material may be added by forming several layers of material with each layer stacked on top of the previous layer. Examples of additive manufacturing include melting a filament to form each layer of the 3D object (e.g., fused filament fabrication), curing a resin to form each layer of the 3D object (e.g., stereolithography), sintering, melting, or binding powder to form each layer of the 3D object (e.g., selective laser sintering or melting, multijet fusion, metal jet fusion, etc.), and binding sheets of material to form the 3D object (e.g., laminated object manufacturing, etc.).

### BRIEF DESCRIPTION OF THE DRAWINGS

FIG. 1 is a flow diagram illustrating an example of a method for powder reclamation determination;

FIG. 2 is a block diagram illustrating examples of engines for powder reclamation;

FIG. 3 is a block diagram of an example of an apparatus that may be used in powder reclamation;

FIG. 4 is a block diagram illustrating an example of a computer-readable medium for powder reclamation;

FIG. 5 is a diagram illustrating an example of a build volume and isolation meshes; and

FIG. 6 is a block diagram illustrating an example of engines to determine how much powder degradation will occur for a 3D print.

### DETAILED DESCRIPTION

Additive manufacturing may be used to manufacture three-dimensional (3D) objects. 3D printing is an example of additive manufacturing. In many types of 3D printing, layers of powder are delivered to a build volume. After each layer is delivered, heat is applied to portions of the layer to cause the powder to coalesce (e.g., sinter) in those portions and/or to remove solvents from a binding agent. For example, a fusing agent or a binding agent may be applied to portions that should coalesce or bind, and/or a detailing agent may be applied to portions that should not coalesce. An energy source may deliver energy that is absorbed by the fusing agent to cause the powder to coalesce. Additional layers are delivered and selectively heated to build up a 3D object from the coalesced powder. After all of the layers have been delivered and heated, the build volume is allowed to cool for a period of time. The 3D objects are then removed from the powder bed. The remaining powder can be recycled or discarded. Recycling the powder reduces waste and reduces the cost of printing each object.

Unfortunately, the powders may degrade and oxidize when exposed to elevated temperatures. For example, polymer powders, such as polyamide 12 (PA 12), may degrade during 3D printing due to the exposure to elevated temperatures. In some examples, the powder may spend 30 to 40 hours above 160° C. during the printing and cooling process, which is sufficient to cause powder degradation. Repeated printing may cause the powder to become degraded enough to affect the 3D printing process. For example, degraded powder may cause surface distortions, such as an orange peel effect, poor mechanical properties, off-gassing that creates porosity in the part, and the like.

Various remediation techniques may be used to limit the degradation. For example, antioxidant packages may be included inside the powder, but the degradation may still occur. Using a nitrogen environment during 3D printing can reduce oxidation. However, oxygen can be dissolved in the powder or can enter the powder. Accordingly, the remediation techniques may have limited effectiveness. Moreover, the remediation techniques may increase the printing cost.

The degradation can also be remediated by mixing fresh powder with recycled powder. As used herein, the term “fresh powder” refers to powder that has not been used for 3D printing, and the term “recycled powder” refers to powder that has been through the 3D printing process. A quality metric may be used to determine the amount of degradation of the powder. For example, the quality metric may be the relative solution viscosity, the molecular weight, or the like, which may correlate with the amount of degradation. For PA 12, the quality metric may be a measurement of color. The amount of degradation of PA 12 is highly correlated with the color of the powder. For example, the amount of degradation is highly correlated with the b* component of the Commission on Illumination L*a*b* (CIELAB) color space. In some examples, degradation and/or powder quality may be measured and/or represented with b*. For instance, the quality metric may be associated with powder color (e.g., yellowness index (YI), American Society for Testing and Materials (ASTM) E313[3]).

Fresh powder can be added to the recycled powder to keep the quality metric above a threshold. For example, a user may target to use powder with a b* of less than 4. Unfortunately, it can be difficult to discern how much powder will degrade during a particular print. The powder may experience a 30-40 hour temperature profile. The degradation is affected by the ability of gases to diffuse into the surrounding environment, which in turn depends on the arrangement of parts, and by the amount of agent (e.g., a detailing agent, a color agent, or the like) delivered to the powder.

Powder degradation estimation (e.g., prediction and/or simulation) may be performed to determine a powder refresh ratio, which may reduce a total cost of ownership and controlling manufactured object quality. For instance, an object made of powders that are over-stressed thermally may result in reduced quality.

A voxel is a representation of a location in a 3D space. For example, a voxel may represent a volume or component of a 3D space. For instance, a voxel may represent a volume that is a subset of the 3D space. In some examples, voxels may be arranged on a 3D grid. For instance, a voxel may be rectangular or cubic in shape. Examples of a voxel size dimension may include 25.4 millimeters (mm)/150≈170 microns for 150 dots per inch (dpi), 490 microns for 50 dpi, 0.5 mm, 1 mm, 2 mm, 4 mm, 5 mm, etc. A set of voxels may be utilized to represent a build volume.

A build volume is a volume in which an object or objects may be manufactured. For instance, a build volume may be a representation of a physical volume and/or may be an actual physical volume in which an object or objects may be manufactured. A “build” may refer to an instance of 3D manufacturing. A layer is a portion of a build volume. For example, a layer may be a cross section (e.g., two-dimensional (2D) cross section or a 3D portion) of a build volume. In some examples, a layer may refer to a horizontal portion (e.g., plane) of a build volume. In some examples, an “object” may refer to an area and/or volume in a layer and/or build volume indicated for forming an object.

Some examples of the techniques described herein may estimate (e.g., predict and/or simulate) the thermal stress a build may inflict on powder contained in each voxel of that build. Some examples of the techniques may determine a quantity of reclaimed powder (e.g., a mass of recoverable powder in each voxel). Some examples of the techniques may calculate which voxels may be excluded from powder reclamation to enhance the quality of the reclaimed powder. Reclaimed powder is powder that may be recycled and/or reused for subsequent manufacturing. In some examples, the quality of a blend (e.g., mixture) of polymer powder at varying levels of degradation may follow a quadratic mean of constituent degradation levels. Accordingly, highly degraded voxels may have a disproportionate impact on the quality of a powder blend. By removing, for example, 2 kilograms (kg) of the most highly degraded powder in a build, approximately 5 kg of fresh powder may be saved, which otherwise may have been used to counteract the impact of the highly degraded voxels and maintain a target powder quality level.

While plastics (e.g., polymers) may be utilized as a way to illustrate some of the approaches described herein, some the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi Jet Fusion (MJF), Metal Jet Fusion, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples, “powder” may indicate or correspond to particles. In some examples, an object may indicate or correspond to a location (e.g., area, space, etc.) where particles are to be sintered, melted, or solidified. For example, an object may be formed from sintered or melted powder.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

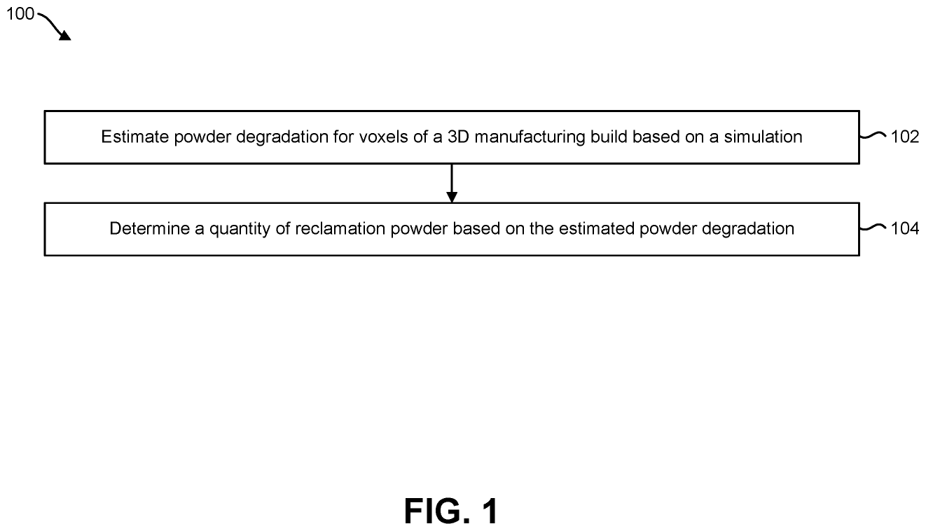

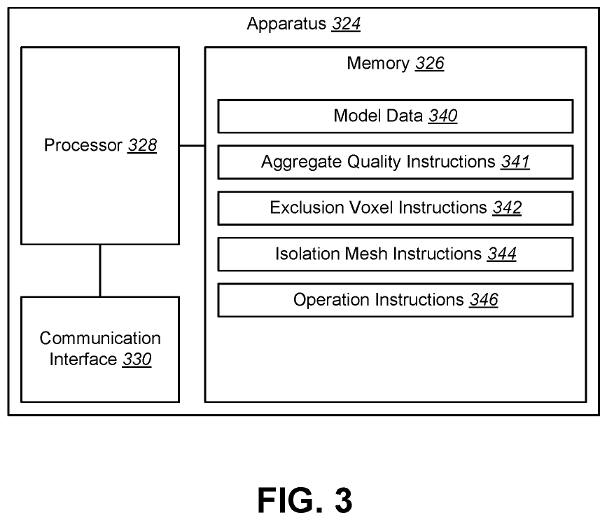

FIG. 1 is a flow diagram illustrating an example of a method 100 for powder reclamation determination. For example, the method 100 may be performed to determine a quantity of reclaimed powder from a build. The method 100 and/or an element or elements of the method 100 may be performed by an electronic device. For example, the method 100 may be performed by the apparatus 324 described in relation to FIG. 3.

The apparatus may estimate 102 powder degradation for voxels of a 3D manufacturing build based on a simulation. For example, the simulation (e.g., physics-based thermal simulation) may determine a plurality of thermal states that will be experienced by powder at a voxel of a 3D build volume as a result of printing a particular build. Each thermal state may correspond to a time during the printing and/or during cooling from the printing. For example, the simulation may determine for each time during the printing what the thermal state of the voxel will be based on the operations of the printer up to that point in time, previous thermal states, and/or the environmental/boundary conditions. In some examples, the simulation may simulate the thermal states of all the voxels in the build volume (e.g., all the voxels that include powder at that point in time) and the thermal state of each voxel may be determined (e.g., determined partially) based on the thermal states of other voxels (e.g., nearby voxels) at previous points in time. The simulation may determine (e.g., predict and/or calculate) the thermal states of the voxel during cooling based on the previous thermal states of the voxel or other voxels and/or based on the environmental/boundary conditions.

In some examples, estimating 102 the powder degradation may include determining voxel stresses. For instance, a stress to the powder at a voxel or voxels may be calculated based on the plurality of thermal states. The term “stress” refers to a number indicative of how much degradation will be experienced by the powder due to an environmental factor. The amount of degradation may depend on the interaction between multiple environmental factors, so various amounts of degradation may result from a particular amount of stress due to one environmental factor depending on the state of other environmental factors. The environmental factors may include the temperature, the amount of oxygen present at or near the voxel (or how well the oxygen is able to diffuse from the voxel), the amount of water or other substances present at or near the voxel (e.g., due to humidity, agents delivered to the print volume, etc.), or the like. The stress may or may not be in defined units. For example, the stress may be specified in a set of custom arbitrary units. In addition, stresses from different environmental factors may be in different units. In some examples, a stress may be calculated based on the plurality of thermal states by suitably combining values representing the thermal states into a scalar value representing the stress.

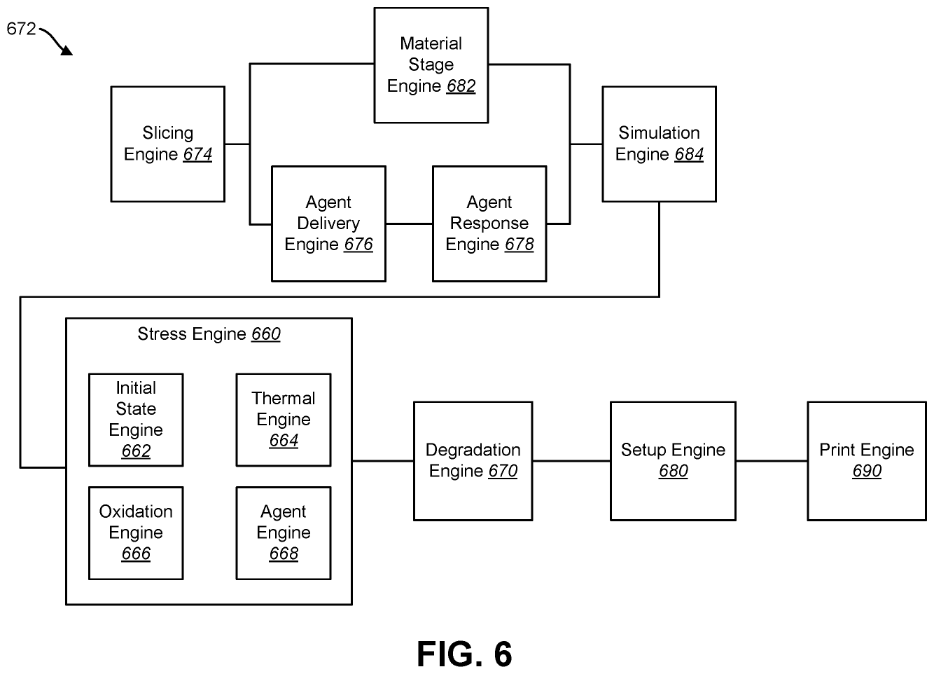

In some examples, estimating 102 the powder degradation may include determining an amount of degradation of the powder at the voxel or voxels based on the stress or stresses. For instance, a degree of degradation resulting from the interaction of other environmental factors with the stress from the thermal states may be determined. In some examples, the degradation may be quantified in terms of a quality metric. For example, the degree of degradation may be estimated by determining a quality metric for the powder at the voxel after printing, by specifying a change in the quality metric that will result from printing, and/or the like. In some examples, estimating 102 the powder degradation may be accomplished as described in relation to FIG. 6.

The apparatus may determine 104 a quantity of reclamation powder based on the estimated powder degradation. Reclamation powder is powder for reclamation (e.g., powder to be reclaimed, powder selected for reclamation, etc.). For instance, reclamation powder may be reclaimed for use in a subsequent printing procedure (e.g., reused for a subsequent build). After printing, for instance, a build volume may include an object or objects, trapped powder, reclaimable powder, and/or reclamation powder. An object is a solidified mass. Trapped powder is powder that is trapped within an object and/or that may be practically inaccessible after printing (without extracting the powder from the object, for instance). Reclaimable powder is powder that is accessible (e.g., powder that is not stuck to the surface of an object, powder that is outside of the object or objects, etc.). Reclaimable voxels are voxels corresponding to reclaimable powder. Reclamation powder is powder that is determined for reclamation. For example, reclamation powder may be the reclaimable powder or a subset of the reclaimable powder. Reclamation voxels are voxels corresponding to reclamation powder. In some examples, reclamation powder may correspond to reclamation voxels determined (e.g., selected) from reclaimable voxels.

In some examples, determining 104 a quantity of reclamation powder may include determining reclamation voxels from reclaimable voxels based on the estimated powder degradation. For instance, reclamation voxels may be determined as reclaimable voxels that meet a criterion (e.g., less than or not more than a degree of estimated degradation). In some examples, the apparatus may determine the reclamation voxels by excluding reclaimable voxels that do not satisfy the criterion (e.g., that have more than or at least a degree of estimated degradation). For instance, reclaimable voxels that have more than or at least a threshold b* value may be excluded to determine the reclamation voxels. In some examples, the apparatus may determine the reclamation voxels by excluding some reclaimable voxels to achieve a target quality level. For instance, some reclaimable voxels with a degree (e.g., higher degree) of estimated degradation may be excluded such that a blend of reclamation powder and fresh powder will achieve the target quality level.

A target quality level is a number that expresses an overall (e.g., aggregate) quality level for an amount of powder (e.g., a blend of reclamation powder and fresh powder). In some examples, a target quality level may be expressed in terms of b* for an amount of powder. The target quality level may be a quality level to avoid print defects and/or to maintain a print quality level. In some examples, the target quality level may be received from an input device (e.g., set by a user). An example of a target quality level may be b*=4. Other examples of target quality levels (e.g., 2, 3, 4, 4.5, 5, etc.) may be utilized in some examples.

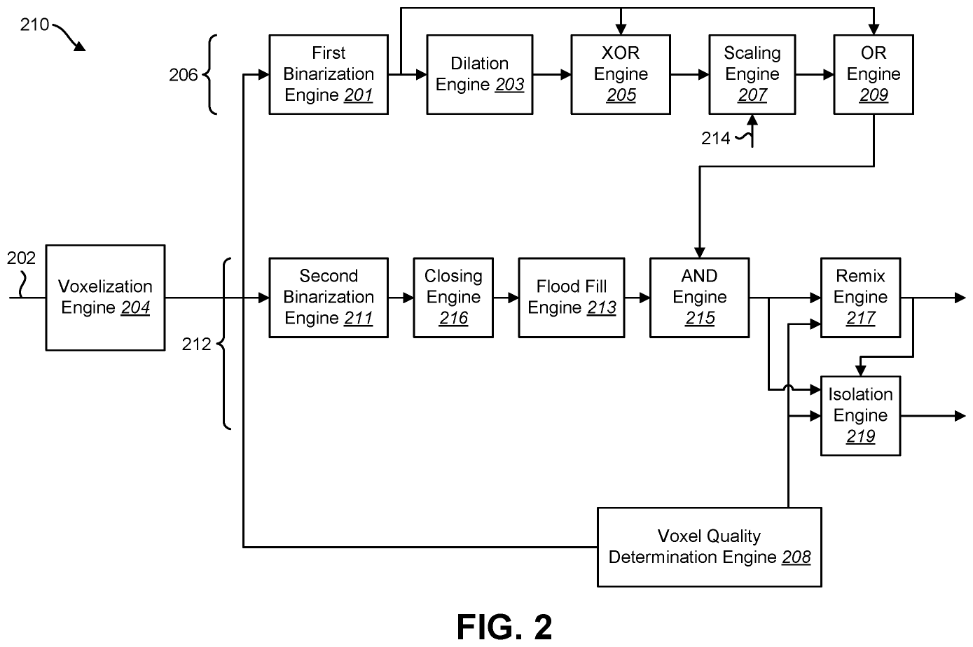

In some examples, an apparatus may determine (e.g., select) reclamation voxels from the reclaimable voxels using a binary search. An example of a binary search is described in relation to FIG. 2. In some examples, an apparatus may determine (e.g., select) the reclamation voxels from the reclaimable voxels using a closed form approach.

In some examples, determining 104 the quantity of reclamation powder based on the estimated powder degradation may include determining a mass of the reclamation powder corresponding to reclamation voxels. For instance, determining the mass of the reclamation powder corresponding to the reclamation voxels may include adding masses of reclamation voxels and/or multiplying a voxel mass (e.g., mass per voxel) by the amount (e.g., number) of reclamation voxels. In some examples, the quantity of reclamation powder (e.g., mass of reclamation powder) may be utilized to determine a mass of fresh powder to add to the reclamation powder to achieve a target quality level.

FIG. 2 is a block diagram illustrating examples of engines 210 for powder reclamation. As used herein, the term “engine” refers to circuitry (e.g., analog or digital circuitry, a processor, such as an integrated circuit, or other circuitry, etc.) or a combination of instructions (e.g., programming such as machine- or processor-executable instructions, commands, or code such as a device driver, programming, object code, etc.) and circuitry. Some examples of circuitry may include circuitry without instructions such as an application specific integrated circuit (ASIC), a Field Programmable Gate Array (FPGA), etc. A combination of circuitry and instructions may include instructions hosted at circuitry (e.g., an instruction module that is stored at a processor-readable memory such as random-access memory (RAM), a hard-disk, or solid-state drive, resistive memory, or optical media such as a digital versatile disc (DVD), and/or executed or interpreted by a processor), or circuitry and instructions hosted at circuitry.

In some examples, the engines 210 may include a voxelization engine 204, a first binarization engine 201, a dilation engine 203, an exclusive or (XOR) engine 205, a scaling engine 207, an OR engine 209, a second binarization engine 211, a closing engine 216, a flood fill engine 213, an AND engine 215, a remix engine 217, an isolation engine 219, and/or a voxel quality determination engine 208. In some examples, one, some, or all of the operations described in relation to FIG. 2 may be performed by the apparatus 324 described in relation to FIG. 3. For instance, instructions for voxelization, first binarization, dilation, XOR, scaling, OR, second binarization, closing, flood fill, AND, remix, isolation, and/or voxel stress determination may be stored in memory and executed by a processor in some examples. In some examples, an operation or operations (e.g., voxelization, first binarization, dilation, XOR, scaling, OR, second binarization, flood fill, AND, remix, isolation, and/or voxel stress determination, etc.) may be performed by another apparatus. For instance, voxelization may be carried out on a separate apparatus and sent to the apparatus. In some examples, one, some, or all of the operations described in relation to FIG. 2 may be performed in the method 100 described in relation to FIG. 1.

Model data 202 may be obtained. For example, the model data 202 may be received from another device and/or generated. Model data is data indicating a model or models of an object or objects. A model is a geometrical model of an object or objects. A model may specify shape and/or size of a 3D object or objects. In some examples, model may be expressed using polygon meshes and/or coordinate points. For example, a model may be defined using a format or formats such as a 3D manufacturing format (3MF) file format, an object (OBJ) file format, computer aided design (CAD) file, and/or a stereolithography (STL) file format, etc. In some examples, the model data indicating a model or models may be received from another device and/or generated. For instance, an apparatus may receive a file or files of model data and/or may generate a file or files of model data. In some examples, an apparatus may generate model data with model(s) created on the apparatus from an input or inputs (e.g., scanned object input, user-specified input, etc.).

The voxelization engine 204 may voxelize the model data 202 by dividing the model data 202 into a plurality of voxels. In some examples, the build volume may be a rectangular prism, and the voxels may be rectangular prisms. For example, the voxelization engine 204 may slice the build volume with planes parallel to the XY plane, the YZ plane, and XZ plane to form the voxels. In some examples, a 3D printer may have a printing resolution, such as a resolution in the XY plane and a resolution along the Z axis. The voxelization engine 204 may voxelize (e.g., slice) the model data 202 into voxels with sizes equal to the resolution of the 3D printer, into larger voxels, and/or into smaller voxels. Some examples of voxel sizes may include 0.2 mm, 0.25 mm, 0.5 mm, 1 mm, 2 mm, 4 mm, 5 mm, etc. In some examples, each voxel may have an associated value that indicates a degree to which the voxel is filled (by an object, for instance). For instance, the associated value may be within a range of values (e.g., 0-255). In some examples, the value may be encoded as a channel in a color space. For instance, a voxel may have an associated value between 0-255 representing a range between black and white. The voxels produced by the voxelization engine 204 may be provided to the first binarization engine 201, the second binarization engine 211, and the voxel quality determination engine 208.

In some examples, the engines 210 may be arranged into different paths. For instance, a cleaning compensated voxel determination path 206 may include the first binarization engine 201, the dilation engine 203, the XOR engine 205, the scaling engine 207, and/or the OR engine 209. The cleaning compensated voxel determination path 206 may be utilized to produce cleaning compensated reclamation voxels. For example, the cleaning compensated voxel determination path 206 may determine perimeter voxels around an object of the 3D manufacturing build. Perimeter voxels are voxels that encompass or surround an object. For example, perimeter voxels may represent powder that may adhere to an object and/or that may not be reclaimed.

In some examples, the first binarization engine 201, the dilation engine 203, and/or the XOR engine 205 may be utilized to determine the perimeter voxels. For instance, the first binarization engine 201 may binarize a set of voxels to determine binary voxels including object voxels and non-object voxels. Binary voxels are voxels that have a binary value (e.g., 0 or 1). For instance, a binary value may indicate that an object occupies a voxel or does not occupy a voxel. In some examples, the first binarization engine 201 may utilize a threshold. For instance, the first binarization engine 201 may compare the values of the voxels from the voxelization engine 204 to the threshold. In some examples, if a value satisfies the threshold, then the corresponding voxel may be assigned a binary value (e.g., 0 or 1). For instance, the threshold may be utilized to determine whether the value indicates that the voxel is more filled than not. In some examples, the threshold may be 128. For instance, if a value of a voxel is ≥128, then the voxel may be assigned a binary value of 1, indicating that the binary voxel is occupied by an object. Otherwise, the voxel may be assigned a binary value of 0, indicating that the voxel is empty. Voxels with a binary value indicating that the voxels are occupied may be the object voxels. Voxels with a binary value indicating that the voxels are empty may be the non-object voxels.

In some examples, the dilation engine 203 may dilate the object voxels to produce expanded voxels. Dilating the object voxels may include adding new object voxels around the object voxels. For instance, the dilation engine 203 may change non-object voxels in contact with the outer surface of the object voxels to new object voxels to produce the expanded voxels. In some examples, the dilation engine 203 may add a shell of new object voxels around the object voxels to produce the expanded voxels. The added object voxels may have a thickness of a voxel or voxels (e.g., 1 voxel, 2 voxels, 4 voxels, etc.). The expanded voxels may be the binary voxels with the added new object voxels and/or shell. The expanded voxels may be provided to the XOR engine.

The XOR engine 205 may perform an XOR operation with the expanded voxels and the binary voxels to produce the perimeter voxels. For instance, the XOR engine 205 may produce the perimeter voxels by indicating those voxels that have different binary values between the expanded voxels and the binary voxels. For instance, the perimeter voxels may indicate a region (e.g., 0.5 mm, 1 mm, 2 mm, etc., region) around each object in the build volume. In some examples, the perimeter voxels may indicate the voxels that were added in dilation with a value of 1 and other voxels with a value of 0. The perimeter voxels (e.g., 0.5-1 mm perimeter region) may be provided to the scaling engine 207.

In some examples, the cleaning compensated voxel determination path 206 may scale the perimeter voxels based on a reclamation calibration value 214 to produce scaled perimeter voxels. The reclamation calibration value 214 is a number indicating an amount (e.g., ratio) of powder in the perimeter voxels that may be reclaimed. For instance, different cleaning approaches may result in different amounts of powder (e.g., potentially reclaimable powder) cleaned from printed objects. In some examples, different users (e.g., cleaning technicians) may vary in thoroughness when cleaning printed objects. The reclamation calibration value 214 may account for the variation in different cleaning approaches and/or thoroughness. The reclamation calibration value 214 may be determined by printing an arbitrary build, weighing the object(s) after powder reclaim, and weighing the parts again after cleaning to determine the mass of powder attached to the object(s). The reclamation calibration value 214 may indicate a proportion of the mass of powder attached to the object(s) after cleaning. For instance, the reclamation calibration value 214 may be represented as a number between 0-1 and/or may be encoded in another range (e.g., in 8 bits for a 0-255 range in a continuous tone image). The scaling engine 207 may scale the perimeter voxels based on the reclamation calibration value 214 by applying the reclamation calibration value 214 (e.g., multiplying the reclamation calibration value 214) to the perimeter voxels to produce the scaled perimeter voxels. In some examples, the perimeter voxels and/or the scaled perimeter voxels may be encoded in a range (e.g., a continuous tone image, 8 bits, 0-255 range, etc.). The scaled perimeter voxels may represent an amount of powder that can be reclaimed from the perimeter voxels (while using a coarse (e.g., 0.5 mm) voxel grid, for instance). In some examples, the scaling may be user-dependent and/or not geometry-dependent. The scaled perimeter voxels may be provided to the OR engine 209.

The OR engine 209 may determine cleaning compensated reclamation voxels based on the scaled perimeter voxels. For instance, the OR engine 209 may determine the cleaning compensated reclamation voxels by performing an OR operation with the scaled perimeter voxels and the binary voxels to produce the cleaning compensated reclamation voxels. In some examples, the cleaning compensated reclamation voxels may be a combination of the object voxels (from the binary voxels) and the scaled perimeter voxels. Cleaning compensated reclamation voxels are voxels determined based on a cleaning compensation calibration (e.g., the reclamation calibration value 214). The cleaning compensated reclamation voxels may be provided to a reclamation powder determination path 212 (e.g., to the AND engine 215). In some examples, the quantity of reclamation powder may be determined based on the cleaning compensated reclamation voxels. For instance, the cleaning compensated reclamation voxels may be utilized to determine the quantity of reclamation powder.

In some examples, the reclamation powder determination path 212 may include the second binarization engine 211, the closing engine 216, the flood fill engine 213, the AND engine 215, the remix engine 217, and/or the isolation engine 219. The second binarization engine 211 may binarize a set of voxels to determine second binary voxels including second object voxels and second non-object voxels. In some examples, the second binarization engine 211 may utilize a threshold (e.g., a greedy threshold). Some examples of a threshold (e.g., greedy threshold) may treat any voxel that contains some portion of an object as an object voxel (e.g., a voxel that is occupied 1% volume or more by an object may be indicated as a voxel that is 100% occupied by an object by volume). For instance, the second binarization engine 211 may compare the values of the voxels from the voxelization engine 204 to the threshold. In some examples, the second binarization engine 211 may operate similar to the first binarization engine 201. In some examples, the second binarization engine 211 may use a different threshold and/or may operate on a different size of voxel relative to the first binarization engine 201. In some examples, the first binarization engine 201 and the second binarization engine 211 may be combined into a single binarization engine (for approaches where the voxel size and threshold used are the same, for instance). The second binary voxels may be provided to the closing engine 216.

In some examples, the reclamation powder determination path 212 may determine free powder voxels. Free powder voxels are voxels that are not occupied by an object and/or are not trapped inside an object. For instance, an aspect of determining recoverable powder may include detecting powder that is trapped inside of an object or objects. Trapped powder may occur due to printing a hollow object or may be powder trapped inside of an object that is difficult to reclaim due to no openings or a small opening or openings in the object.

In some examples, the reclamation powder determination path 212 may determine (e.g., approximate) the amount of trapped powder by performing a binary closing operation. For instance, the closing engine 216 may perform dilation. For instance, the closing engine 216 may add voxels around object voxels to dilate the object voxels to form a closing shell (which may close a hole or holes in the object(s), for instance). In some examples, the closing engine 216 may perform erosion. For instance, the closing engine 216 may reduce the size of the closing shell. In some examples, the dilation and/or erosion may be performed at a scale (e.g., 0.5-4 mm). The voxel array resulting from the closing engine 216 may be provided to the flood fill engine 213.

In some examples, determining the free powder voxels may include performing a flood fill of the 3D manufacturing build. For instance, the flood fill engine 213 may mark voxels that are accessible and/or outside of the closed object(s) indicated by the voxel array from the closing engine 216. The marked voxels may represent the free powder voxels. For instance, any voxels marked by the flood fill operation may be free powder voxels. Unmarked voxels may represent object(s), powder trapped in object(s), and/or perimeter voxels. The free powder voxels (e.g., marked voxels) may be provided to the AND engine 215.

In some examples, the reclamation powder determination path 212 may perform an AND operation with the cleaning compensated reclamation voxels (from the OR engine, for instance) and the free powder voxels to produce reclaimable voxels. For instance, the AND engine 215 may overlaying the cleaning compensated reclamation voxels (e.g., perimeter powder recoverable fractions) with the free powder voxels to obtain an indication of which voxels are reclaimable. In some examples, a mass of reclaimable powder may be determined based on the reclaimable voxels. The reclaimable voxels may be provided to the remix engine 217 and/or to the isolation engine 219.

The voxel quality determination engine 208 may determine voxel quality corresponding to the voxels (e.g., voxels provided by the voxelization engine 204). In some examples, determining the voxel quality (e.g., voxel stress(es), estimated powder degradation, and/or quality metric(s)) may be performed as described in relation to FIG. 1 and/or FIG. 6. For instance, the voxel quality determination engine 208 may determine estimated powder degradation, voxel stresses, and/or quality metrics based on a simulation. In some examples, the estimated powder degradation may be expressed in terms of a quality metric (e.g., b*) for each voxel. The quality metrics may be provided to the remix engine 217 and/or the isolation engine 219.

In some examples, the remix engine 217 may determine reclamation data based on the reclaimable voxels and/or the quality metrics. Reclamation data is data regarding an aspect or aspects of powder reclamation. For example, by using (e.g., combining) cleaning compensated voxel data, reclaimable voxel data, and/or quality metrics (e.g., b* values) of each voxel, the remix engine 217 may determine an overall mass and/or aggregate quality level of the powder (e.g., reclaimable powder and/or reclamation powder, etc.). In some examples, the remix engine 217 may determine object mass, mass of trapped powder, mass of waste powder on the surface of object(s), refresh ratio to maintain a target quality level, and/or net impact of a build on the used powder supply. A refresh ratio is a ratio of reclaimed powder and fresh powder.

In some examples, the mass and/or aggregate quality level of reclaimed powder can be re-evaluated based on removing degraded powder (starting from the most highly degraded powder, for instance), which may result in an updated refresh ratio and/or an updated powder surplus estimate.

In some examples, the remix engine 217 may determine reclamation data in accordance with one, some, or all of the following Equations. Equation (1) expresses an approach for determining an aggregate quality level (in terms of b*) of voxels of equal mass.

$${Q}_{level} = \sqrt{\frac{1}{n} {\sum }_{i = 1}^{n} {b}_{i}^{2}} \qquad ( 1 )$$

In Equation (1), Qₗₑᵥₑₗ is the aggregate quality level, b is a quality metric (e.g., b*) for a voxel i, n is a quantity of voxels of equal mass (e.g., reclaimable voxels and/or reclamation voxels), and i is an index of the voxels.

Equation (2) expresses an approach for determining an aggregate quality level (in terms of b*) of voxels of mass m.

$${Q}_{level} = \sqrt{\frac{{\sum }_{i = 1}^{N} {m}_{i} {b}_{i}^{2}}{{\sum }_{i = 1}^{N} {m}_{i}}} \qquad ( 2 )$$

In Equation (2), Qₗₑᵥₑₗ is the aggregate quality level, b is a quality metric (e.g., b*) for a voxel i, N is a quantity of voxels (e.g., reclaimable voxels and/or reclamation voxels), m is a mass of voxel i, and i is an index of the voxels. In some examples, the remix engine 217 may determine the aggregate quality level of voxels based on the estimated powder degradation (e.g., quality metrics of the voxels). For instance, the aggregate quality level may be determined in accordance with Equation (1) and/or Equation (2).

Equation (3) expresses an approach for determining a refresh ratio to produce a powder blend with a target quality level.

$$R = \frac{{b}_{t}^{2} - {b}_{r}^{2}}{{b}_{f}^{2} - {b}_{r}^{2}} \qquad ( 3 )$$

In Equation (3), R is the refresh ratio, bₜ is the target quality level, bᵣ is the quality level of the reclaimable and/or reclamation voxels, and bf is the quality level of fresh powder.

Equation (4) expresses an approach for determining a mass of fresh powder to produce a powder blend with a target quality level.

$${m}_{f} = \frac{{m}_{r} * R}{1 - R} \qquad ( 4 )$$

In Equation (4), m_{f} is the mass of fresh powder and mᵣ is a mass of reclaimable and/or reclamation powder. In some examples, the remix engine 217 may determine a mass of fresh powder (e.g., m_{f}) to produce a powder blend with a target quality level. For instance, the remix engine 217 may determine the mass of fresh powder in accordance with Equation (4).

In some examples, determining a quantity of reclamation powder may include determining a mass of the reclamation powder (e.g., mᵣ) corresponding to reclamation voxels. For instance, the remix engine 217 may determine the mass of reclamation powder by adding the voxel masses of the reclamation voxels and/or for equal voxel mass, multiplying a voxel mass by a quantity of reclamation voxels. The mass of the reclamation powder (e.g., mᵣ) may be utilized to determine the mass of fresh powder (e.g., m_{f}) to produce a powder blend with a target quality level.

In some examples, the remix engine 217 may determine reclamation voxels from reclaimable voxels. For instance, the remix engine 217 may utilize a binary search approach to iteratively remove a portion of the reclaimable voxels such that the remaining reclamation voxels mixed with fresh powder may maintain a target quality level. In some examples, a binary search approach may be utilized to achieve a powder-neutral build. A powder-neutral build is a build where the total mass of powder and (e.g., plus) objects in the build volume before reclamation and/or recycling is approximately equal to the total mass of reclamation powder and (e.g., plus) fresh powder. The total mass of the objects and powder for a build may be established factors. The mass and quality level (e.g., b*) of the reclamation powder may depend on a fraction of the reclaimable powder that is excluded. The mass of fresh powder to produce blended powder at a target quality level (e.g., target b*) may be determined in accordance with Equation (4) above (and may be deterministic based on the reclamation powder level). The binary search approach may be iteratively calculated. In some examples, a closed form approach may be utilized.

The binary search approach may utilize a percentile estimate. The percentile estimate may represent a proportion (e.g., mass fraction) of reclaimable powder to be reclaimed (e.g., non-excluded powder). For instance, the percentile estimate may be a ratio of a mass of reclamation powder and a mass of reclaimable powder. For instance, a percentile estimate of 0.9 may mean that 0.9 or 90% of reclaimable powder (e.g., powder to be reclaimed) and/or that 0.1 or 10% of reclaimable powder (e.g., the worst 10%) is to be excluded. The percentile estimate may be initialized to a value (e.g., 0.5).

The binary search approach may include a quantity of iterations (e.g., K). For instance, a loop operation or operations may iterate for a variable k in a range (e.g., k=1, 2, . . . , K, where K=11 or another number). Equation (5) illustrates an example of a loop operation in a binary search approach.

(bᵣ,mᵣ)=calc_remix(build,fractionᵣ=percentile) (5)

In Equation (5), bᵣ is the quality level of the reclamation powder, mᵣ is a mass of reclamation powder, calc_remix is a remix calculation function, build is a build being evaluated, fractionᵣ is a fraction of reclaimable powder to be reclaimed, and percentile is the percentile estimate. For instance, the calc_remix function may be utilized to determine the mass and b* value of a blend including all reclaimable powder below a b* percentile (e.g., percentile 0.9 may mean that the worst 10% of reclaimable powder is excluded from the reclamation powder). In some examples, the calc_remix function may take the build voxels (“build”), each having a mass and b* value, and fractionᵣ. The calc_remix function may filter the build (e.g., build voxels) to the least degraded powder voxels. For instance, if fractionᵣ=0.9, the worst 10% of voxels are removed from consideration. The calc_remix function may compute the mass mᵣ (e.g., a summation of powder mass for each voxel under consideration) and the b* of the aggregate blend in accordance with the equation:

$${b}_{r} = \sqrt{\frac{\sum {{m}_{i} ( {b}_{i} )}^{2}}{\sum {m}_{i}}} ,$$

where mᵢ is the mass of voxel i (of the filtered voxels) and bi is the b* value of voxel i.

Equation (6) illustrates an example of an operation to calculate a mass of fresh powder based on mass of quality level of reclamation powder and mass of reclamation powder. The operation may be a loop operation in a binary search approach.

m_{f}=calc_fresh(bₜ,bᵣ,mᵣ) (6)

In Equation (6), bₜ is a target quality level, bᵣ is the quality level of the reclamation voxels and/or powder, mᵣ is a mass of reclamation voxels and/or powder, m_{f} is the mass of fresh powder, and calc_fresh is a fresh powder mass calculation function. In some examples, the calc_fresh function may be a combination of Equations (3) and (4), (e.g.,

$$R = \frac{{b}_{t}^{2} - {b}_{r}^{2}}{{b}_{f}^{2} - {b}_{r}^{2}} and {m}_{f} = {m}_{r} * \frac{R}{1 - R} ) .$$

For instance, the refresh ratio (e.g., R) to achieve the target b* level may be determined first. Then, the mass of fresh powder (e.g., m_{f}) may be determined based on R and mᵣ.

Equation (7) illustrates an example of an operation to calculate a mass difference. The operation may be a loop operation in a binary search approach.

m_{Δ}=m_{b}−(mᵣ+m_{f}) (7)

In Equation (7), m_{Δ} is the mass difference, m_{b} is a build mass (e.g., total mass of powder mass+object(s) mass in a build), mᵣ is a mass of reclamation voxels and/or powder, and m_{f} is the mass of fresh powder.

In an example of the binary search approach, the percentile estimate may be updated based on a comparison of a net mass (e.g., m_{Δ}) and a threshold. For example, if net mass is less than 0, then the percentile estimate may be updated in accordance with Equation (8).

$$percentile = percentile + {( \frac{1}{2} )}^{( k + 1 )} \qquad ( 8 )$$

Otherwise, the percentile mass may be updated in accordance with Equation (9).

$$percentile = percentile - {( \frac{1}{2} )}^{( k + 1 )} \qquad ( 9 )$$

At the end of the loop (e.g., iterating 10 times, from k=1 to k=10), the remix engine 217 may have calculated a percentile threshold for excluded powder to remain powder neutral (e.g., the percentile threshold may be calculated to within 0.00097 in a 0-1 range). For example, the percentile estimate may be a value such as 0.85, meaning that the worst 15% of the reclaimable powder is excluded from the reclamation powder. In some examples, excluding the calculated amount for a full build may reduce the amount of fresh powder used to achieve the target quality level (e.g., b* level) by several kilograms.

In some examples, an apparatus may display a reclamation datum or data. For instance, an apparatus may display a mass of fresh powder (to produce a target quality level of a powder blend, for instance), quality metrics, mass of reclaimable powder, mass of reclamation powder, a visualization of the voxels of the build volume, a visualization of quality metrics (e.g., b*) for the voxels, a visualization of reclaimable powder, a visualization of reclamation powder, percentile estimate, quality level of reclaimable powder, and/or quality level of reclamation powder, etc. In some examples, the apparatus may send the reclamation datum or data to another device. For instance, the apparatus may send the reclamation datum or data to a smartphone, tablet device, server, etc.

In some examples, the reclamation datum or data may be provided to the isolation engine 219. The isolation engine 219 may determine an isolation object or objects. An isolation object is an object to isolate powder. For instance, an isolation object may be a hollow object added to the build to contain portions of powder. For example, isolation object(s) may be utilized to isolate the most highly degraded voxels for a mass of powder (e.g., excluded powder, non-reclamation powder, etc.). In some examples, the isolation engine 219 may determine an isolation mesh. For instance, the isolation engine 219 may determine exclusion voxels. Exclusion voxels are voxels of powder (e.g., reclaimable powder) that are excluded from the reclamation powder. For instance, the isolation engine 219 may select the most degraded voxels (e.g., voxels with the poorest quality metrics) to achieve the percentile estimate of reclamation powder (e.g., up to 1—percentile estimate). The isolation engine 219 may determine the isolation mesh based on the exclusion voxels. For instance, the isolation engine 219 may determine an isolation mesh that encloses the exclusion voxels. In some examples, the isolation mesh may be a hollow mesh with a wall thickness of 0.5-2 mm. In some examples, the isolation mesh or meshes may be printed in a 3D manufacturing build. For instance, the isolation mesh(es) may be sent to a 3D printer and/or added to a build for printing. The printed isolation meshes may help to extract the degraded powder during reclamation.

In some examples, an engine(s) and/or path(s) described in relation to FIG. 2 may utilize different voxel sizes. For instance, the first binarization engine 201, the second binarization engine 211, and/or the voxel quality determination engine 208 may produce voxels of different sizes. In some examples, voxels (and/or corresponding data) may be downsampled and/or upsampled for use with different engine(s) and/or path(s).

FIG. 3 is a block diagram of an example of an apparatus 324 that may be used in powder reclamation. The apparatus 324 may be a computing device, such as a personal computer, a server computer, a printer, a 3D printer, a smartphone, a tablet computer, etc. The apparatus 324 may include and/or may be coupled to a processor 328, a communication interface 330, and/or a memory 326. In some examples, the apparatus 324 may be in communication with (e.g., coupled to, have a communication link with) an additive manufacturing device (e.g., a 3D printer). In some examples, the apparatus 324 may be an example of 3D printer. The apparatus 324 may include additional components (not shown) and/or some of the components described herein may be removed and/or modified without departing from the scope of the disclosure.

The processor 328 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 326. The processor 328 may fetch, decode, and/or execute instructions stored on the memory 326. In some examples, the processor 328 may include an electronic circuit or circuits that include electronic components for performing a functionality or functionalities of the instructions. In some examples, the processor 328 may perform one, some, or all of the aspects, elements, techniques, etc., described in relation to one, some, or all of FIGS. 1-6.

The memory 326 is an electronic, magnetic, optical, and/or other physical storage device that contains or stores electronic information (e.g., instructions and/or data). The memory 326 may be, for example, Random Access Memory (RAM), Electrically Erasable Programmable Read-Only Memory (EEPROM), a storage device, an optical disc, and/or the like. In some examples, the memory 326 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 326 may be a non-transitory tangible machine-readable storage medium, where the term “non-transitory” does not encompass transitory propagating signals. In some examples, the memory 326 may include multiple devices (e.g., a RAM card and a solid-state drive (SSD)).

The apparatus 324 may further include a communication interface 330 through which the processor 328 may communicate with an external device or devices (not shown), for instance, to receive and store the information pertaining to an object or objects. The communication interface 330 may include hardware and/or machine-readable instructions to enable the processor 328 to communicate with the external device or devices. The communication interface 330 may enable a wired or wireless connection to the external device or devices. The communication interface 330 may further include a network interface card and/or may also include hardware and/or machine-readable instructions to enable the processor 328 to communicate with various input and/or output devices, such as a keyboard, a mouse, a display, another apparatus, electronic device, computing device, printer, etc., through which a user may input instructions into the apparatus 324.

In some examples, the memory 326 may store model data 340. The model data 340 may include and/or indicate a model or models (e.g., 3D object model(s)). The apparatus 324 may generate the model data 340 and/or may receive the model data 340 from another device. In some examples, the memory 326 may include slicing and/or voxelization instructions (not shown in FIG. 3). For example, the processor 328 may execute the slicing and/or voxelization instructions to voxelize the 3D model data to produce voxels of a build.

The memory 326 may store aggregate quality instructions 341. For example, the aggregate quality instructions 341 may be instructions for determining an aggregate quality level of non-object voxels of a 3D manufacturing build. In some examples, the processor 328 may execute the aggregate quality instructions 341 to determine an aggregate quality level of non-object voxels (e.g., reclaimable voxels and/or reclamation voxels) of a 3D manufacturing build. In some examples, the processor 328 may determine the aggregate quality level as described in relation to FIG. 1 and/or FIG. 2 (e.g., Equation (2)).

In some examples, the memory 326 may store exclusion voxel instructions 342. The processor 328 may execute the exclusion voxel instructions 342 to determine exclusion voxels based on the aggregate quality level. In some examples, determining the exclusion voxels may be performed as described in relation to FIG. 1 and/or FIG. 2. For instance, the processor 328 may determine a percentile estimate of reclamation powder based on the aggregate quality level. The exclusion voxels may be selected as an amount of the most highly degraded voxels of reclaimable powder (e.g., 0.15) to meet the percentile estimate (e.g., 0.85).

In some examples, the memory 326 may store isolation mesh instructions 344. The processor 328 may execute the isolation mesh instructions 344 to determine an isolation mesh based on the exclusion voxels. In some examples, determining the isolation mesh may be performed as described in relation to FIG. 1 and/or FIG. 2. In some examples, the processor 328 may determine the isolation mesh by performing marching cubes on the exclusion voxels.

The memory 326 may store operation instructions 346. In some examples, the processor 328 may execute the operation instructions 346 to perform an operation based on the aggregate quality level and/or the isolation mesh. In some examples, the processor 328 may execute the operation instructions 346 to determine a quantity of fresh powder to achieve a target quality level. In some examples, the processor 328 may determine the quantity of fresh powder as described in relation to FIG. 1 and/or FIG. 2. For instance, the processor 328 may utilize the aggregate quality level to determine a quantity of fresh powder (e.g., mass of fresh powder) to produce a target quality level of a blend of the fresh powder and reclamation powder. In some examples, the processor 328 may utilize the aggregate quality level to solve for a refresh ratio, which may be utilized to determine the quantity of fresh powder.

In some examples, the processor 328 may execute the operation instructions 346 to instruct a printer to print the isolation mesh in a 3D manufacturing build. In some examples, the processor 328 may instruct the printer to print the isolation mesh as described in relation to FIG. 1 and/or FIG. 2. For instance, the processor 328 may add the isolation mesh to the build, which may be sent to a printer for printing. For instance, the apparatus 324 may utilize the communication interface 330 to send the isolation mesh and/or build to a printer for printing.

In some examples, the operation instructions 346 may include 3D printing instructions. For instance, the processor 328 may execute the 3D printing instructions to print a 3D object or objects. In some examples, the 3D printing instructions may include instructions for controlling a device or devices (e.g., rollers, print heads, thermal projectors, and/or fuse lamps, etc.). For example, the 3D printing instructions may use a build (including the isolation mesh, for instance) to control a print head or heads to print an agent or agents in a location or locations specified by the build. In some examples, the processor 328 may execute the 3D printing instructions to print a layer or layers. In some examples, the processor 328 may execute the operation instructions to present a visualization or visualizations of the build, the isolation meshes, the aggregate quality level, and/or other reclamation data on a display and/or send the visualization or visualizations of the build, the isolation meshes, the aggregate quality level, and/or other reclamation data to another device (e.g., computing device, monitor, etc.).

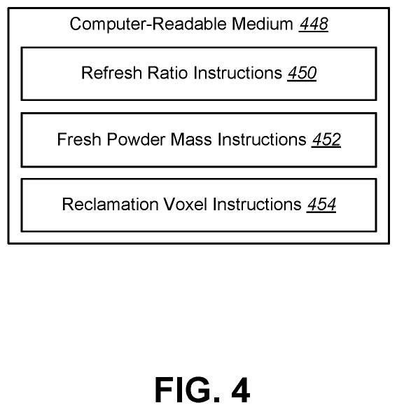

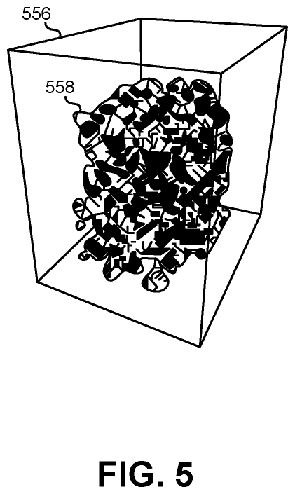

FIG. 4 is a block diagram illustrating an example of a computer-readable medium 448 for powder reclamation. The computer-readable medium 448 is a non-transitory, tangible computer-readable medium. The computer-readable medium 448 may be, for example, RAM, EEPROM, a storage device, an optical disc, and the like. In some examples, the computer-readable medium 448 may be volatile and/or non-volatile memory, such as DRAM, EEPROM, MRAM, PCRAM, memristor, flash memory, and the like. In some examples, the memory 326 described in relation to FIG. 3 may be an example of the computer-readable medium 448 described in relation to FIG. 4. In some examples, the computer-readable medium may include code, instructions and/or data to cause a processor perform one, some, or all of the operations, aspects, elements, etc., described in relation to one, some, or all of FIG. 1, FIG. 2, FIG. 3, FIG. 4, FIG. 5, and/or FIG. 6.

The computer-readable medium 448 may include code (e.g., data and/or instructions). For example, the computer-readable medium 448 may include refresh ratio instructions 450, fresh powder mass instructions 452, and/or reclamation voxel instructions 454.

The refresh ratio instructions 450 may include code to cause a processor to determine a refresh ratio of reclamation powder and fresh powder to achieve a target quality level. In some examples, determining a refresh ratio of reclamation powder and fresh powder to achieve a target quality level may be performed as described in relation to FIG. 1, FIG. 2, and/or FIG. 3. For example, the refresh ratio instructions 450 may include code to cause the processor to determine the refresh ratio based on reclaimable voxels and quality metrics.

The fresh powder mass instructions 452 may include code to cause a processor to determine a mass of the fresh powder based on the refresh ratio. In some examples, determining a mass of the fresh powder based on the refresh ratio may be performed as described in relation to FIG. 1, FIG. 2, and/or FIG. 3.

The reclamation voxel instructions 454 may include code to cause a processor to determine the reclaimable voxels based on cleaning compensated reclamation voxels. In some examples, determining the reclaimable voxels based on cleaning compensated reclamation voxels may be performed as described in relation to FIG. 1, FIG. 2, and/or FIG. 3.

FIG. 5 is a diagram illustrating an example of a build volume 556 and isolation meshes 558. For instance, an apparatus may determine isolation meshes 558 to isolate and/or contain degraded powder as described in relation to FIG. 1, FIG. 2, FIG. 3, and/or FIG. 4. In some examples, the isolation meshes 558 may be printed as hollow objects to isolate the degraded powder. After printing, the objects printed from the isolation meshes 558 may be removed and/or discarded. The remaining reclamation powder may be reclaimed and/or blended with fresh powder for printing in a subsequent build.

FIG. 6 is a block diagram illustrating an example of engines 672 to determine how much powder degradation will occur for a 3D print. The engines 672 may include a slicing engine 674. The slicing engine 674 may slice a build file to determine a plurality of voxels. The build file may include data that describes a plurality of objects to be printed within a build volume, including the pose of the objects within the build volume. The slicing engine 674 may slice the build file by dividing the build volume into a plurality of voxels. In some examples, the build volume may be a rectangular prism, and the voxels may be rectangular prisms. For example, the slicing engine 674 may slice the build volume with planes parallel to the XY plane, the YZ plane, and XZ plane to form the voxels. The 3D printer may have a printing resolution, such as a resolution in the XY plane and a resolution along the Z axis. The slicing engine 674 may slice the build file into voxels with sizes equal to the resolution of the 3D printer, into larger voxels, or into smaller voxels. There is a tradeoff between larger voxel sizes that allow for more efficient computation and smaller voxel sizes that provide a finer resolution of the powder degradation.

The engines 672 may include an agent delivery engine 676. The agent delivery engine 676 may determine the amount of agent that will be delivered to the powder at each voxel. The agent delivery engine 676 may determine the amount of fusing agent, the amount of detailing agent, the amount of binding agent, the amount of a property modification agent, the amount of a coloring agent, or the like that will be delivered. For example, the agent delivery engine 676 may determine the amount of agent that will be delivered based on the build file. The agent delivery engine 676 may compute a continuous tone map that indicates how much agent will be delivered to each voxel. The agent delivery engine 676 may use a deterministic approach to determine the amount of agent to be delivered to achieve or prevent coalescing (or another property) at various locations, may use a machine learning (e.g., deep learning) model to determine the amount of agent to be delivered, or the like. The machine learning model may be trained based on the deterministic approach to achieve similar results more quickly. For example, the machine learning model may quickly determine the amount of agent that will be received by a voxel with a lower resolution than the resolution than the printer without computing continuous tone (e.g., contone) maps at the print resolution. The agent delivery engine 676 may include a separate model or sub-engine to determine the amount of each agent used during the print process. The amount of agent delivered may depend on the model of the 3D printer, the version of instructions running on the 3D printer, the arrangement of the 3D printer, the settings of the 3D printer, the setup of the 3D printer, or the like. Accordingly, the agent delivery engine 676 may determine the amount of agent to be delivered based on the model of the 3D printer, the version of instructions, or the like.

The engines 672 may include an agent response engine 678. The agent response engine 678 may determine a temperature response that will be experienced by the powder at each voxel from the amount of the agent that will be delivered. For example, the 3D printer may apply energy to the build volume, and the amount of agent delivered to a voxel affects how much energy is absorbed by the powder at that voxel. Accordingly, the agent response engine 678 may determine the temperature response based on the amount of agent and the amount of energy to be delivered to the voxel. The agent response engine 678 may determine the amount of energy to be delivered or select a relationship between agent and temperature based on the model of the 3D printer, the version of instructions running on the 3D printer, the arrangement, the settings, the setup, or the like. In some examples, the 3D printer may deliver energy to select voxels without use of an agent. In such examples, the engines 672 may include an engine to determine the amount of energy delivered to each voxel without determining the amount of agent delivered. In some examples, the agent delivery engine 676 and/or the agent response engine 678 may perform deep learning operations to predict the thermal conditions in a fusing layer for the simulation engine 684.

The engines 672 may include a material state engine 682 to determine a coalescence state that will result for the powder at each voxel. For example, the material state engine 682 may determine which voxels include an object and which do not based on the slices of the build file. The material state engine 682 may select a coalesced state for voxels that include an object and an uncoalesced state for voxels without an object. In some examples, the material state engine 682 may include various states between coalesced and uncoalesced for voxels that include an object and loose powder.

The engines 672 may include a simulation engine 684 to determine a plurality of thermal states that will be experienced by the powder at each voxel as a result of printing the build specified by the build file. For example, the simulation engine 684 may determine an initial thermal state of each voxel based on the results from the agent delivery engine 676 and the agent response engine 678. The simulation engine 684 may determine thermal states after the initial thermal state based on conduction of heat among voxels and loss of heat to the environment. The simulation engine 684 may determine the amount of conduction based on the coalescence state of each voxel determined by the material state engine 682.

The simulation engine 684 may progress through a series of time increments and determine the thermal state of each voxel at each time increment. In some examples, not yet printed voxels may be ignored until they are formed. In examples, the simulation engine 684 may generate a four-dimensional (4D) representation of the build volume that includes a temperature for each time and voxel location (e.g., 3D cartesian location). At each time increment, the simulation engine 684 may compute the thermal states for each voxel based on the thermal states from the immediately previous increment, the agent response for any new voxels, and the loss of thermal energy at the boundary of the build volume. The time increment may be selected based on the desired resolution. Larger increments may allow for quicker computation and smaller increments may provide more precise results for the thermal experience of each voxel. Different time increments may be selected for time when the printer is printing versus when the build volume is cooling. In some examples, the time increments for printing may be selected to have a plurality of time increments during the formation of each voxel (e.g., at the resolution generated by the slicing engine 674). The time increments during cooling may be larger (e.g., an order of magnitude or two larger). The simulation engine 684 may generate thermal states for each voxel from its formation until the end of the cooling period.

The engines 672 may include a stress engine 660. The stress engine 660 may calculate a stress to the powder at each voxel. The stress engine 660 may determine the stress based on the plurality of thermal states. The stress engine 660 may determine impacts of environmental factors on the amount of degradation of the powder at each voxel. As used herein, the term “environment” refers to anything at the voxel or surrounding the voxel that affects the degradation of the powder at a voxel. The term “environmental factor” refers to an attribute or limited set of attributes of the environment that affect the degradation of the powder at a voxel. The environmental factors may include heat, oxygen, agents, or the like. The term “impact” refers to a value (e.g., an alphanumeric value) representative of the influence of the environmental factor on the degradation of the powder. The impact may represent how the environmental factor will interact with the stress to produce degradation of the powder (e.g., how the environmental factor will amplify or dampen the effects of the stress). In the illustrated example, the stress engine 660 includes an initial state engine 662, a thermal engine 664, an oxidation engine 666, and an agent engine 668. The initial state engine 662 may determine an initial value indicative of an initial amount of powder degradation prior to printing. For example, the initial state engine 662 may determine the initial value based on the quality metric (e.g., b*) of the powder before printing, which may be determined from measuring the powder or based on the results of a previous simulation. Measurements may be input by a user, received from a measuring device, or retrieved from a non-transitory computer-readable medium. For some materials, the change in quality metric may be non-linearly related to the stress. For example, the change in quality metric for a particular stress may depend on the initial state of the quality metric. The initial state engine 662 may determine the initial value by converting the initial quality metric to a value in a domain with a linear relationship to a stress.

The thermal engine 664 may determine heat interactions with the powder at the voxel that will result in stress to the powder. For example, the thermal engine 664 may determine the stress to each voxel from the thermal states of that voxel throughout the printing process. The thermal engine 664 may determine the thermal stress based on a version of the Arrhenius equation. In an example, the thermal engine 664 may compute the thermal stress according to Equation (10):

$${σ}_{Thermal} = {\sum }_{m} {t}_{m} {e}^{( {a}_{0} - \frac{{E}_{a}}{{RT}_{m}} )} \qquad ( 10 )$$

Where σ_{Thermal} is the thermal stress at a voxel, the sum is over all time increments m, tₘ is the duration of a time increment m, a₀ is a constant specific to the material, Eₐ is the activation energy and is specific to the material and environment, R is the gas constant, and Tₘ is the temperature of the voxel at time increment m. In some examples, some time increments may have different lengths.

The oxidation engine 666 may determine oxidative interaction with the powder at the voxel that will result in stress to the powder. For example, the amount of degradation may depend on the amount of oxygen present at each voxel, which may in turn depend on whether oxygen is able to diffuse away from the voxel. The oxidation engine 666 may determine based on the pose of objects in the build volume whether there is coalesced powder blocking oxygen from diffusing. For example, the oxidation engine 666 may use the results from the material state engine 682 to determine which voxels will be in a coalesced state that prevents diffusion. Based on the states of the voxels, the oxidation engine 666 may determine how much oxygen is able to diffuse away from the voxel. The oxidation engine 666 may determine a value for each voxel indicative of how much interaction there will be between oxygen and the powder at that voxel, which value may be referred to as an oxidation metric.

The agent engine 668 may determine printing agent interaction with the powder at the voxel that will result in stress to the powder. For example, a detailing agent, a fusing agent, a binding agent, a property modification agent, a coloring agent, or the like may be applied to the powder. The amount of degradation of the powder may depend on the amount of agent present at each voxel or at neighboring voxels. The agent engine 668 may receive from the agent delivery engine 676 an indication of how much agent will be delivered to each voxel. The agent engine 668 may determine a value for each voxel indicative of how much the agents may interact with that voxel, which value may be referred to as an agent metric. The agent engine 668 may use the indication received from the agent delivery engine 676 as the agent metric or may compute the agent metric based on the indication.

The engines 672 may include a degradation engine 670. The degradation engine 670 may determine an amount of degradation of the powder at the voxel based on the stress. For example, the degradation engine 670 may compute the amount of degradation based on the initial value from the initial state engine 662, the thermal stress from the thermal engine 664, the oxidation metric from the oxidation engine 666, and the agent metric from the agent engine 668. In some examples, the degradation engine 670 may receive multiple values from the initial state engine 662, the thermal engine 664, the oxidation engine 666, and the agent engine 668. For example, the agent engine 668 may include a value for each type of agent that may interact with a voxel, or separate values may be produced based on separate equations or models that capture different ways in which heat, oxygen, or agent interact with the powder at the voxel.

The degradation engine 670 may compute, for each voxel, a quality metric or change in quality metric that will result from the particular print job. In an example using PA12, the degradation engine 670 may compute a b* value that will result from the print job or a change in b* value that will result from the print job. In some examples, the degradation engine 670 may compute a value indicative of the amount of degradation in the same domain as the initial value from the initial state engine 662 and convert the computed value into the quality metric domain (e.g., the b* domain). In examples, the degradation engine 670 may compute the quality metric directly without first computing a value in an intermediate domain.

The degradation engine 670 may include a machine learning model to compute the quality metric based on the values from the stress engine 660. The machine learning model may include a support vector regression, a neural network, or the like. For each voxel, the machine learning model may receive the initial value from the initial state engine 662, the thermal stress, the oxidation metric, the agent metric, or multiple such values and output the quality metric or change in quality metric for that voxel that will result from the print job. The machine learning model may be trained based on data from actual print jobs. For example, the inputs for the machine learning model during training may be computed as discussed above based on the build file for the actual print job. The ground truth for the output from the machine learning model may be determined by measuring the quality metric (e.g., the b* value) for the powder at a particular voxel (e.g., a sample of powder from the particular voxel). The machine learning model can be trained using values in the quality metric domain as ground truth, or the ground truth quality metric values can be converted to ground truth intermediate values used to train the machine learning model. In some examples, the quality metric(s) produced by the degradation engine 670 may be an output of the voxel quality determination engine 208 described in relation to FIG. 2. For instance, the quality metric(s) may be provided to the remix engine 217 and/or the isolation engine 219. In some examples, an engine or engines of the engines 672 may be included in the voxel quality determination engine 208 described in relation to FIG. 2. For instance, the agent delivery engine 676, the agent response engine 678, the material stage engine 682, the simulation engine 684, the stress engine 660 and/or the degradation engine 670 may be included in the voxel quality determination engine 208 in some examples.

The engines 672 may include a setup engine 680. The setup engine 680 may select a setup of the three-dimensional print based on the amount of degradation. For example, the setup engine 680 may select a ratio of fresh powder to recycled powder to use during the three-dimensional print. The setup engine 680 may include previously specified rules or receive user specified rules about the quality metric. The rules may specify that the quality metric for a worst-case voxel, average voxel, median voxel, or the like remain below a particular threshold. The setup engine 680 may determine based on a quality metric for the recycled powder how much fresh powder to add to meet the specifications of the rules. The quality metric for the recycled powder may have been measured or computed by the degradation engine 670 for a previous print job. In a PA12 example, the setup engine 680 may compute the b* value that results from combining recycled and fresh powder by computing a weighted root mean square of the b* values for each powder added weighted by the amount of that powder added. The setup engine 680 may compute an initial quality metric value that will result in the print job satisfying the rules and determine the amount of fresh powder to add to achieve that initial quality metric value. In some examples, the setup engine 680 may select the setup of the three-dimensional print by modifying settings of the three-dimensional printer, modifying the print job, or the like.

The engines 672 may include a print engine 690. The print engine 690 may instruct a 3D printer to print the print job with the selected setup. For example, the print engine 690 may transmit a build file, indications of printer settings, indications of the amount of fresh or recycled powder to use, or the like to the 3D printer and may indicate to the 3D printer to print using the transmitted information. The 3D printer may operate according to the transmitted information to form a build volume corresponding to the build file according to the specified settings with powder from the specified sources.

Some examples of the techniques described herein may help to determine how much fresh powder to be added for a build. For instance, it may be difficult to identify and/or selectively avoid reclaiming specific powder regions that include highly degraded powder when processing a build trolley. When using materials such as PA12, highly degraded powder may mix with other powder as objects are removed and as less degraded powder is reclaimed, which may result in degraded powder diffusion.

Some of the techniques described herein may determine where the highly degraded powder voxels will be for a given build. The location of the highly degraded powder voxels may be used with target powder quality and used powder production to automatically determine which powder voxels to exclude in order to achieve the target powder quality. This may enable producing build arrangements and/or matched refresh ratios that maintain a given quality level and are net consumers of used powder, that are used powder neutral (e.g., producing as much used powder as is consumed), or that are net producers of used powder. This may provide enhanced control over the quality of recycled powder and cost to maintain that quality.

Some examples of the techniques described herein may enable identification of and/or targeted removal of degraded powder voxels. For instance, some examples of the techniques may provide accurate determination of reclaimable powder voxels, including calibration for an amount of powder reclaimed from the surface of objects. Some examples of the techniques described herein may provide a determination of aggregated quality of reclaimable and/or reclamation powder voxels. Some examples of the techniques described herein may indicate removal of reclaimable voxels containing highly degraded powder to maintain a target powder quality with a reduced amount of fresh powder. Some examples of the techniques described herein may enable planning for costs of a build before printing (e.g., determining mass of objects, mass of powder trapped in printed objects, mass of powder lost on surface of objects, and/or an amount of fresh powder to replenish a trolley following a build).

Some examples of the techniques described herein may include a closed loop approach for removing degraded powder voxels from a build. For instance, some examples may include techniques to simulate voxel level powder degradation for a build and estimate the mass and quality of recyclable powder with certain voxels excluded. Some examples may include techniques to target powder voxels for exclusion from reclamation based on target powder quality and allowable waste. Some examples may include techniques to accurately assess which powder voxels are reclaimable, including calibration of powder reclaimed from the surface of objects.

As used herein, the term “and/or” may mean an item or items. For example, the phrase “A, B, and/or C” may mean any of: A (without B and C), B (without A and C), C (without A and B), A and B (without C), B and C (without A), A and C (without B), or all of A, B, and C.

While various examples are described herein, the disclosure is not limited to the examples. Variations of the examples described herein may be implemented within the scope of the disclosure. For example, aspects or elements of the examples described herein may be omitted or combined.

1. A method, comprising:
estimating powder degradation for voxels of a three-dimensional (3D) manufacturing build based on a simulation; and
determining a quantity of reclamation powder based on the estimated powder degradation.

2. The method of claim 1, further comprising:
determining perimeter voxels around an object of the 3D manufacturing build; and
scaling the perimeter voxels based on a reclamation calibration value to produce scaled perimeter voxels; and
determining cleaning compensated reclamation voxels based on the scaled perimeter voxels, wherein the quantity of reclamation powder is determined based on the cleaning compensated reclamation voxels.

3. The method of claim 2, wherein determining the perimeter voxels comprises:
binarizing a set of voxels to determine binary voxels including object voxels and non-object voxels;
dilating the object voxels to produce expanded voxels; and
performing an exclusive or (XOR) operation with the expanded voxels and the binary voxels to produce the perimeter voxels.

4. The method of claim 3, wherein determining the cleaning compensated reclamation voxels comprises performing an OR operation with the scaled perimeter voxels and the binary voxels to produce the cleaning compensated reclamation voxels.

5. The method of claim 2, further comprising:
determining free powder voxels;
performing an AND operation with the cleaning compensated reclamation voxels and the free powder voxels to produce reclaimable voxels.

6. The method of claim 5, wherein determining the free powder voxels comprises performing a flood fill of the 3D manufacturing build.

7. The method of claim 1, wherein determining the quantity of reclamation powder comprises determining a mass of the reclamation powder corresponding to reclamation voxels.

8. The method of claim 1, further comprising determining an aggregate quality level of the voxels based on the estimated powder degradation.

9. The method of claim 8, further comprising determining a mass of fresh powder to produce a powder blend with a target quality level.

10. An apparatus, comprising:
a memory; and
a processor coupled to the memory, wherein the processor is to:
determine an aggregate quality level of non-object voxels of a three-dimensional (3D) manufacturing build;
determine exclusion voxels based on the aggregate quality level; and
determine an isolation mesh based on the exclusion voxels.

11. The apparatus of claim 10, wherein the processor is to instruct a printer to print the isolation mesh in the 3D manufacturing build.

12. The apparatus of claim 10, wherein the processor is to determine a quantity of fresh powder to achieve a target quality level.

13. A non-transitory tangible computer-readable medium storing executable code, comprising:
code to cause a processor to determine a refresh ratio of reclamation powder and fresh powder to achieve a target quality level; and
code to cause the processor to determine a mass of the fresh powder based on the refresh ratio.

14. The computer-readable medium of claim 13, wherein the code to cause the processor to determine the refresh ratio comprises code to cause the processor to determine the refresh ratio based on reclaimable voxels and quality metrics.

15. The computer-readable medium of claim 14, further comprising code to cause the processor to determine the reclaimable voxels based on cleaning compensated reclamation voxels.
